(19) United States
(12) Patent Application Publication
(10) Pub. No.: US 2018/0091021 A1
(43) Pub. Date: Mar. 29, 2018

(54) PERMANENT VERTICAL HYDRAULIC WATER CYCLE GENERTOR

(71) Applicant: Taiping ZHONG, Yueyang (CN)

(72) Inventor: Taiping ZHONG, Yueyang (CN)

(21) Appl. No.: 15/800,052

(22) Filed: Oct. 31, 2017

Related U.S. Application Data
(63) Continuation of application No. PCT/CN2016/077643, filed on Mar. 29, 2016.

(30) Foreign Application Priority Data
Jun. 15, 2015 (CN) 201510325801.X

(51) Int. Cl. H02K 7/18

(52) U.S. Cl. CPC H02K 7/1823; F03B 17/005

(57) ABSTRACT

A permanent vertical hydraulic water cycle generator comprises a vertical principle axis, an electric generator installed on an upper end, a plurality of vanes installed on a lower end, at least four oil pressure jacks or four hydraulic oil cylinders uniformly installed around the upper end near the front end of the vanes, a piston provided on the top end of each oil pressure jack, water butted with the piston in a circular tube, and a high-tension switch installed on the top end of the circular tube. The permanent vertical hydraulic water cycle generator generates electricity permanently with a small amount of water and discharged water from air-conditioner as an energy supplement without any support cost, which is environmental friendly and highly profitable.

### TECHNICAL FIELD

In the present invention, a permanent vertical hydraulic water cycle generator comprises a vertical principle axis, an electric generator installed on an upper end, a plurality of vanes installed on a lower end. A lateral side of the plurality of vanes is a horizontal line and a water-flushed side of the plurality of vanes is semicircular. At least four oil pressure jacks or four hydraulic oil cylinders are uniformly installed around the upper end near the front end of the vanes. A piston is provided on the top end of each oil pressure jack. Water is butted with the piston in a circular tube. A high-tension switch is installed on the top end of the circular tube. Two corresponding pairs of oil pressure jacks, pistons, circular tubes as well as high-tension switches for keeping an integrated balance when water flushes the vanes to rotate. The permanent vertical hydraulic water cycle generator enables the water to flush towards the vanes with a maintained certain angle and enables the water out together at one direction. When one pair of the oil pressure jacks stretch, the water in the circular tube flushes the vanes to rotate and drives the electric generator to generate electricity. At the same time, the other pair of the oil pressure jacks shrinks, water is pumped by a pumper and the circular tube is filled with the water. Two pairs of the oil pressure jacks stretch and shrink continuously and constantly so that the water circulation flushes the vanes to rotate constantly at high speed and drives the electric generator to generate electricity.

The electric generator is applicable in various fields requiring electricity, especially in airplanes, trains, ships and vehicles. The permanent vertical hydraulic water cycle generator generates electricity permanently by a small amount of water and discharged water from air-conditioner as an energy supplement without any support cost, and without coal, natural gas.

### BACKGROUND

Although a part of electric generators in the prior art generates energy in use of water flow, solar energy or wind energy, these kinds of generators cannot generate electricity according to a demand, restricted by other conditions. The other part of the electric generators electricity totally relying on coal, natural gas, liquid gas, diesel or gasoline. In order to solve these problems, the present invention disclose a permanent vertical hydraulic water cycle generator.

### SUMMARY

The present invention utilizes water as the power-generating resource, completely getting rids of coal, natural gas, liquid gas, diesel and gasoline, and is able to generate electricity permanently. The technical solution adopted is shown as follows.

The permanent vertical hydraulic water cycle generator comprises a vertical principle axis, an electric generator installed on an upper end, a plurality of vanes installed on a lower end, a lateral side of the plurality of vanes is a horizontal line and a water-flushed side of the plurality of vanes is semicircular. Wherein the plurality of vanes rotates continuously flushed by a water circulation and drives the permanent vertical hydraulic water cycle generator to continuously generate electricity. The plurality of vanes installed on the lower end utilizes a lever principle. The horizontal line is extended indefinitely, and longer extension of the plurality of vanes result in less energy and more work.

At least four oil pressure jacks or four hydraulic oil cylinders are uniformly installed around the upper end near the front end of the vanes. A piston is provided on the top end of each oil pressure jack. Water is butted with the piston in a circular tube. A high-tension switch is installed on the top end of the circular tube. And a certain angle is maintained between a water outlet and the vanes for promoting the water circulation and increasing an impact force of the water outlet.

The permanent vertical hydraulic water cycle generator comprises two corresponding pairs of oil pressure jacks, pistons, circular tubes as well as high-tension switches for keeping an integrated balance when water flushes the vanes to rotate.

The permanent vertical hydraulic water cycle generator comprises oil pressure jacks. When one pair of the oil pressure jacks stretch, the water in the circular tube flushes the vanes to rotate and drives the electric generator to generate electricity. At the same time the other pair of the oil pressure jacks shrinks, water is pumped by a pumper and the circular tube is filled with the water. Two pairs of the oil pressure jacks stretch and shrink continuously and constantly so that the water circulation flushes the vanes to rotate constantly at high speed and drives the electric generator to generate electricity. The water outlet generates electricity when the oil pressure jacks are stretched and shrank.

The permanent vertical hydraulic water cycle generator is applicable in various fields requiring electricity, especially in airplanes, trains, ships and vehicles. It generates electricity permanently by a small amount of water and discharged water from air-conditioner as an energy supplement without any support cost, and without coal, natural gas, liquid gas, diesel or gasoline.

### BRIEF DESCRIPTION OF DRAWINGS

FIG. 1 shows a device schematic diagram of the present invention.

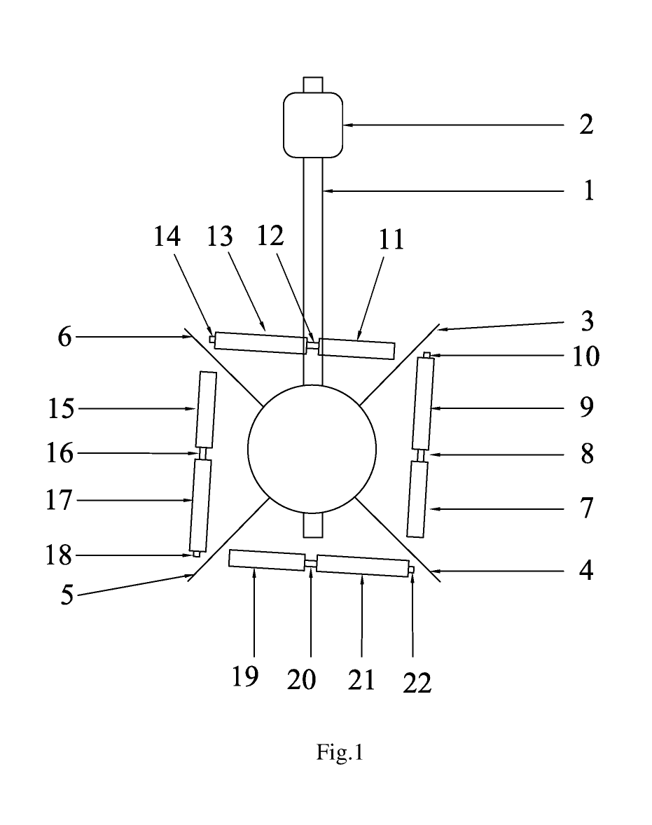

FIG. 2 shows a schematic diagram of an embodiment in the present invention.

The number indication shown in the figures are listed below.

1: vertical principal axis;

2: electric generator;

3: vane;

4: vane;

5: vane;

6: vane;

7: oil pressure jack;

11: oil pressure jack;

15: oil pressure jack;

19: oil pressure jack;

8: pistons;

12: piston;

16: piston;

20: piston;

9: circular tube;

13: circular tube;

17: circular tube;

21: circular tube;

10: high-tension switch;

14: high-tension switch;

18: high-tension switch;

22: high-tension switch.

### DETAILED DESCRIPTION

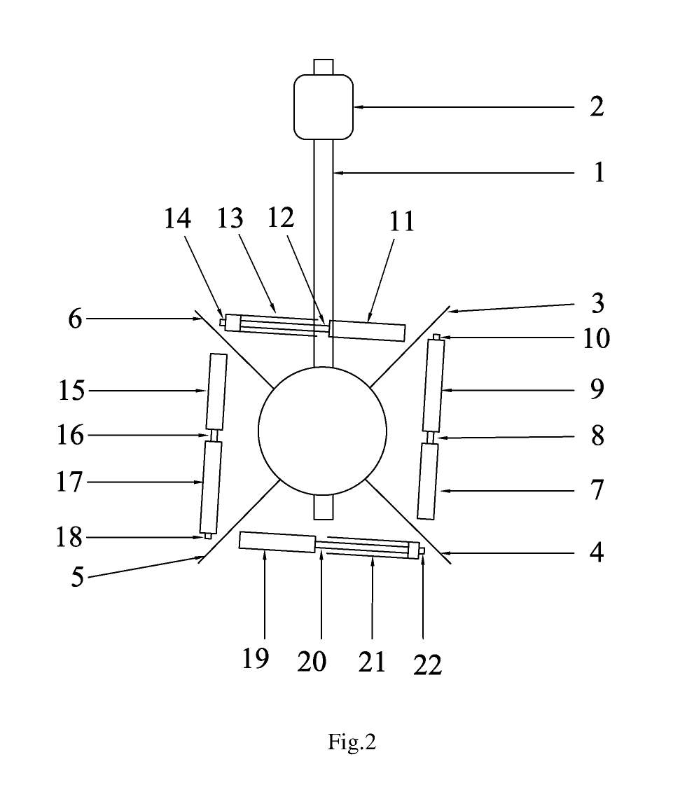

As shown in FIG. 2, the permanent vertical hydraulic water cycle generator comprises a vertical principle axis 1, an electric generator installed on an upper end 2, a plurality of vanes 3, 4, 5 and 6 installed on a lower end. A lateral side of the plurality of vanes is a horizontal line and a water-flushed side of the plurality of vanes is semicircular. At least four oil pressure jacks 7, 11, 15 and 19 or four hydraulic oil cylinders are uniformly installed around the upper end near the front end of the vanes. A piston 8, 12, 16 and 20 is provided on the top end of each oil pressure jack. Water is butted with the piston in a circular tube 9, 13, 17 and 21. A high-tension switch 10, 14, 18 and 22 is installed on the top end of the circular tube. Two corresponding pairs of oil pressure jacks 7, 11, 15 and 19, pistons 8, 12, 16 and 20, circular tubes 9, 13, 17 and 21 as well as high-tension switches 10, 14, 18 and 22 for keeping an balance when water flushes the vanes to rotate. The permanent vertical hydraulic water cycle generator enables the water to flush towards the vanes 3, 4, 5 and 6 with a maintained certain angle and enables the water out together at one direction. When one pair of the oil pressure jacks 11 and 19 stretch, the water in the circular tube flushes the vanes 4 and 6 to rotate and drives the electric generator 2 to generate electricity. At the same time the other pair of the oil pressure jacks 7 and 15 shrinks, water is pumped by a pumper and the circular tube 9 and 17 is filled with the water. Two pairs of the oil pressure jacks 7, 11, 15 and 19 stretch and shrink continuously and constantly so that the water circulation flushes the vanes 3, 4, 5 and 6 to rotate constantly at high speed and drives the electric generator 2 to generate electricity. The electric generator 2 can be a water wheel electric generator, and the oil pressure jacks can be replaced by hydro cylinders.

What is claimed is:

1. A permanent vertical hydraulic water cycle generator, comprising:
a vertical principle axis,
an electric generator installed on an upper end,
a plurality of vanes installed on a lower end;
a lateral side of the plurality of vanes is a horizontal line and a water-flushed side of the plurality of vanes is semicircular; wherein the plurality of vanes rotates continuously flushed by a water circulation and drives the permanent vertical hydraulic water cycle generator to continuously generate electricity;
the plurality of vanes installed on the lower end utilizes a lever principle; the horizontal line is extended indefinitely, and longer extension of the plurality of vanes result in less energy and more work.

2. The permanent vertical hydraulic water cycle generator, according to claim 1, wherein at least four oil pressure jacks or four hydraulic oil cylinders are uniformly installed around the upper end near the front end of the vanes;
a piston is provided on the top end of each oil pressure jack;
water is butted with the piston in a circular tube;
a high-tension switch is installed on the top end of the circular tube; and
a certain angle is maintained between a water outlet and the vanes for promoting the water circulation and increasing an impact force of the water outlet.

3. The permanent vertical hydraulic water cycle generator according to claim 1, comprising
two corresponding pairs of oil pressure jacks, pistons, circular tubes as well as high-tension switches for keeping an integrated balance when water flushes the vanes to rotate.

4. The permanent vertical hydraulic water cycle generator according to claim 1, comprising oil pressure jacks;
when one pair of the oil pressure jacks stretch, the water in the circular tube flushes the vanes to rotate and drives the electric generator to generate electricity;
at the same time the other pair of the oil pressure jacks shrinks, water is pumped by a pumper and the circular tube is filled with the water;
two pairs of the oil pressure jacks stretch and shrink continuously and constantly so that the water circulation flushes the vanes to rotate constantly at high speed and drives the electric generator to generate electricity;
the water outlet generates electricity when the oil pressure jacks are stretched and shrank.

5. The permanent vertical hydraulic water cycle generator according to claim 1, wherein the electric generator is applicable in various fields requiring electricity, especially in airplanes, trains, ships and vehicles;
the permanent vertical hydraulic water cycle generator generates electricity permanently with a small amount of water and discharged water from air-conditioner as an energy supplement without any support cost, and without coal, natural gas, liquid gas, diesel or gasoline.
